(19) United States
(12) Patent Application Publication
(10) Pub. No.: US 2025/0156583 A1
(43) Pub. Date: May 15, 2025

(54) BLOCKCHAIN BASED PRIVACY ENHANCED OUTSOURCED DATA STORAGE

(71) Applicant: NCHAIN LICENSING AG, Zug (CH)

(72) Inventor: Craig Steven WRIGHT, London (GB)

(21) Appl. No.: 18/836,266

(22) PCT Filed: Jan. 23, 2023
(86) PCT No.: PCT/EP2023/051529

§ 371 Date: Aug. 6, 2024

(30) Foreign Application Priority Data
Feb. 7, 2022 (GB) 2201533.3

(51) Int. Cl. G06F 21/64

(52) U.S. Cl. CPC G06F 21/64

(57) ABSTRACT

This application provides methods and systems for verifying safe, consistent and secure storage of data especially, but not limited to, situations where storage of the data is delegated to a third party. A data controller, Alice, takes at least one sample of her data D, performs an operation on it to produce a variation. She then calculates the root value of the Merkle tree that represents the data comprising the varied data sample. She sends her data to a storage provider, Bob, while retaining her sample(s) and the resulting Merkle root value(s). Alice does not tell Bob which sample(s) she has chosen, or the operations she has used in the variations, or any inputs to the operations. Alice can delete her original copy of the data. At a later date, Alice can verify that Bob still has her complete data and in its original state by requiring him to perform the same operation on the same data sample, calculate the root value of the resulting Merkle tree and send it to her. If Bob's root value matches Alice's root value, then Bob must have an original and complete copy of Alice's data otherwise he would not be able to calculate the correct Merkle root value. Embodiments can be arranged to fully automate the process, including implementing on a blockchain.

### CROSS REFERENCE TO RELATED APPLICATIONS

This application is the U.S. National Stage of International Application No. PCT/EP2023/051529 filed on Jan. 23, 2023, which claims the benefit of United Kingdom Patent Application No. 2201533.3, filed on Feb. 7, 2022, the contents of which are incorporated herein by reference in their entireties.

### TECHNICAL FIELD

The present disclosure relates to improved techniques and systems for the secure, efficient and verifiable storage, back up, archive and/or retrieval of electronic data. It is particularly, but not exclusively, suited for use in scenarios where data is stored by a second party (e.g. storage provider) on behalf of a first party (e.g. data owner, creator, controller and/or authorised administrator), even if the second party is not a trusted entity. Example embodiments of the disclosure provide improved solutions for validating, upon demand, the integrity, existence and/or availability of the data stored at or by the second party. Advantages include, but are not limited to, the ability to outsource the storage of potentially large portions of data to secondary locations or devices, thus avoiding or relieving the need for storage and processing resources at a primary location.

### BACKGROUND

In the digital age, data storage is a necessity for organisations and individuals alike. Safe and secure storage of such data may pose challenges for a variety of reasons. For example, the data may have sentimental and/or commercial value; or may be sensitive from a legal, security, military or political perspective; and/or, storage of the data may require resources that the data owner/controller cannot provide. Therefore, for a variety of reasons, it may be desirable to delegate storage of at least a portion of the data to another entity. For example, consider scenarios where an individual wishes to store family video recordings for future posterity; or a company wishes to store large volumes of historical, archived data in order to comply with legal requirements; or an inventor wishes to store experimental data in a time-stamped, verifiable manner but does not have the necessary resources to do so him/herself.

In such situations, the first entity may be an owner, creator, controller, handler and/or administrator of the data. For ease of reference, we refer hereafter to the first entity as the “data controller”. The second entity may be any entity which provides storage for the data at the request of the first entity, and we may refer to this entity as the “storage provider” for ease of reference. The data controller and/or storage provider may be a human, organisational or machine-based entity.

Technical challenges arise in such scenarios because, following storage of the data by the storage provider, the data controller requires proof that the provider a) still has the data and b) that the data has not been modified or compromised relative to its original state. The storage provider needs to be able to provide the data controller with proof of the continued integrity and availability of the data. In order to be reliable, this verification needs to be provided quickly and efficiently, as computationally complex proofs which are costly in terms of time or processing resources are often not acceptable for the entities involved. Further still, it is often desirable to provide proof in a manner that does not require a relationship of trust between the two parties.

Embodiments of the disclosure provide solutions to at least these technical problems.

### SUMMARY

The disclosure provides (at least) improved methods and systems for secure and/or efficient storage of data, or for enabling verification of the data's continued availability and unaltered state. A preferred embodiment may comprise using a Merkle tree to check and/or ensure the integrity of a block/portion of data stored at a data storage provider.

In accordance with a preferred embodiment, a data controller (Alice) wishes to outsource or delegate storage of a portion of data to another entity (Bob) because she is either unable to retain storage of the entire portion of the data herself or does not wish to do so. The disclosure is not limited in respect of the form, structure or purpose of the data. However, Alice will require proof from Bob that he continues to hold an entire copy of the data and that his copy is unaltered from the original version that Alice provided to him.

In a preferred embodiment, Alice organises or arranges the original data (D) into a plurality of segments {m₁, m₂, m₃ . . . m_{N}}. Each segment is a sub-portion of the data D. This organisation/arrangement may comprise dividing the data into logical segments or physically divided segments e.g. by storing one or more of the segments separately from the other(s). In a preferred embodiment, Alice then records or provides the segments in a data storage block (B), and hashes them in pairs to form a Merkle tree, as known in the art. This provides a binary tree (T) which represents the entire, original version of data D and comprises a Merkle root (R) as illustrated in FIG. 7.

Alice selects or otherwise identifies a set (M) of one or more segments and retains it/them. Each segment in set M can be small and thus require little storage space. The term “sample(s)” may also be used hereafter to refer to the segment(s) that Alice retains. Although in some embodiments only one segment may be retained, in a typical embodiment M may comprise more than one segment of original data D so that different samples can be used in separate verification sessions, thus further enhancing security.

Before or after she has identified and stored M, Alice sends the whole block of segments B (and thus a complete copy of D) to Bob. After Bob has received the whole portion of data, Alice deletes her own, whole copy of D while retaining access to the segment(s) M. Upon receipt of the block B from Alice, Bob stores it in a storage resource that he has control of, or at least has access to and can obtain D from at a future date. In example variations, Alice may require acknowledgement of safe receipt of the data from Alice before she deletes her own copy. In other variations, Alice may send the data to Bob D and then he may organise it into a block of segments himself. In such variations, the structure of the segments and/or manner in which individual segments can be identified and referred to may need to be agreed between Alice and Bob, or predetermined in some way.

When Alice subsequently requires verification that Bob still has D and in its original state, she performs one or more operations on at least one segment of M. The operation(s) provide an output (Y), which is the result of processing the at least one segment of M. Alice then calculates the new Merkle root (R′) for the new version of T (T′) in which the original segment used in the operation(s) has been replaced with processed output Y. Hereafter, we may refer use the terms “modify”, “vary” and “replace” interchangeably, but all are intended to include the interpretation that the original version of at least one given segment is overwritten or varied or substituted in some way by a different, subsequent version. “Verification” may mean herein “authentication, proof and/or confirmation”.

Alice then asks Bob to perform the same operation(s) using the same segment in his copy of D. Bob does not know in advance which segments(s) and/or operation(s) Alice is going to ask him to use in the verification proof. Bob then performs the operation using the specified segment(s) from his original copy of the data, to produce output Y. He then calculates the new Merkle tree (T′) and root (R′) for the updated block that includes Y instead of the original segment. He sends the new value for the root R′ to Alice. Alice can then compare the value of Bob's recalculated Merkle root R′ with the value of R′ which she has calculated. If they match, then Bob must have a complete copy of Alice's data, and in the original state that she provided it in. If Bob did not have the entire data, or one part had been changed, he would not be able to calculate the correct value for the proof.

Illustrative embodiments and variations are further described in the following sections, and show that the disclosure provides (at least) the advantages in the following non-exhaustive list:
ability to outsource storage of data to a potentially untrusted storage provider;
enabling a verifiable proof of the data's existence at the storage provider's location, as well as proof that the data has not been altered relative to its original state;
relieving the burden of data storage from data controllers who either cannot or do not wish to store it themselves (e.g. physical storage constraints, legal constraints, business or organizational needs to place data in a shared location etc.)
facilitating proof of data integrity, provenance and authenticity
secure, efficient and swift verification of data availability and integrity
facilitates the design and implementation of wider systems and applications where authenticity and availability of data needs to be verified
allows for the use of simple operations which require few resources in terms of storage or processing, and which can provide a result very quickly
the segments that Alice retains are small, so they do not require a great deal of storage space; this can be advantageous for devices that have limited capacity
Alice does not even need to store the segments themselves; she simply needs to have the parts of the Merkle path which enable her to recalculate them when required; this enables a Simplified Payment Verification (SPV) style verification of block B's contents;
Alice does not need to retain a large set of sample segments; instead, she can change the operation that is performed on her samples, and/or change the parameters she asks Bob to use for the operation. For example, in a first verification she could ask him to concatenate the character ‘G’ to a given segment, and in a subsequent verification ask for the result of an XOR operation on the same or different segment using a randomly generated string of bits as a mask. In a third verification she could ask him to concatenate the character ‘U’ to a the same or a different segment, and so on. Therefore, Alice only needs to retain a few segments to safely allow for many repetitions or variations of the verification process without facilitating Bob's ability to predict the proof that he will be asked to provide
Traditionally, a Merkle proof is used to verify that a particular blockchain transaction is part of the root (i.e. is in a particular block). By contrast, the disclosure uses >=1 sample segments of the block to verify the existence/control/storage of an entire tree of data, not just one part of it. Therefore, even if Alice's block B contains 1 billion segments, she only needs one of those segments to be able to verify, quickly and easily, that all of the segments are present in Bob's copy of the tree/block;
Alice can delegate or authorize verification to another party (Carole) e.g. a third party auditor or some entity that needs verification of existence and authenticity of stored data. Alice can use any suitable technique, such as those disclosed in WO2017/145016, to send or share a secret with Carole. Carole can use the secret to request the verification proof from Bob.
This allows delegation/authorization of 3^{rd} party verification for specific data items, thus improving or at least preserving privacy (i.e. Alice does not need to give Carole access to her entire data storage if Carole only needs to verify certain item(s))
The invention facilitates scalability of technical systems and networks because the storage of data can be securely and verifiably outsourced
Embodiments also provide solutions for solving technical challenges relating to data persistence; it is well known that the commonly used technique of system imaging suffers from the challenge that sufficient RAM is required to hold the entire copy of the data. See: en.wikipedia.org/wiki/Persistence_(computer_science). Embodiments may address this challenge by delegating the storage to the provider.
Embodiments may also provide improved solutions for data back-ups and recovery, and also archiving, file system dumps, versioning and ensuring consistency. See en.wikipedia.org/wiki/Backup.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain;

FIG. 2 schematically illustrates some examples of transactions which may be recorded in a blockchain;

FIG. 3A is a schematic block diagram of a client application;

FIG. 3B is a schematic mock-up of an example user interface that may be presented by the client application of FIG. 3A;

FIG. 4 is a schematic block diagram of some node software for processing transactions;

FIG. 5 provides a flowchart which illustrates an embodiment of the disclosure at an overview level, including at least some of the illustrative steps that may be taken during the storage phase and the subsequent verification stage of the disclosure.

FIG. 6 is an illustration of a preferred embodiment, in which Alice sends a block of data segments to Bob for storage and a copy of the block header to a blockchain for storage in an on-chain transaction. FIG. 6 illustrates some of the steps that may be taken during the storage phase of the disclosure. Some steps shown in FIG. 6 may be omitted in certain embodiments, while others that may be performed are not illustrated in FIG. 6.

FIG. 7 shows a very simply Merkle tree T comprising a Merkle root R and nodes below the root.

FIG. 8 shows a Merkle tree that may be used in accordance with an embodiment of the disclosure, including sample segments {m₁, m₂, m₃, m₄}.

### DETAILED DESCRIPTION OF ILLUSTRATIVE EMBODIMENTS

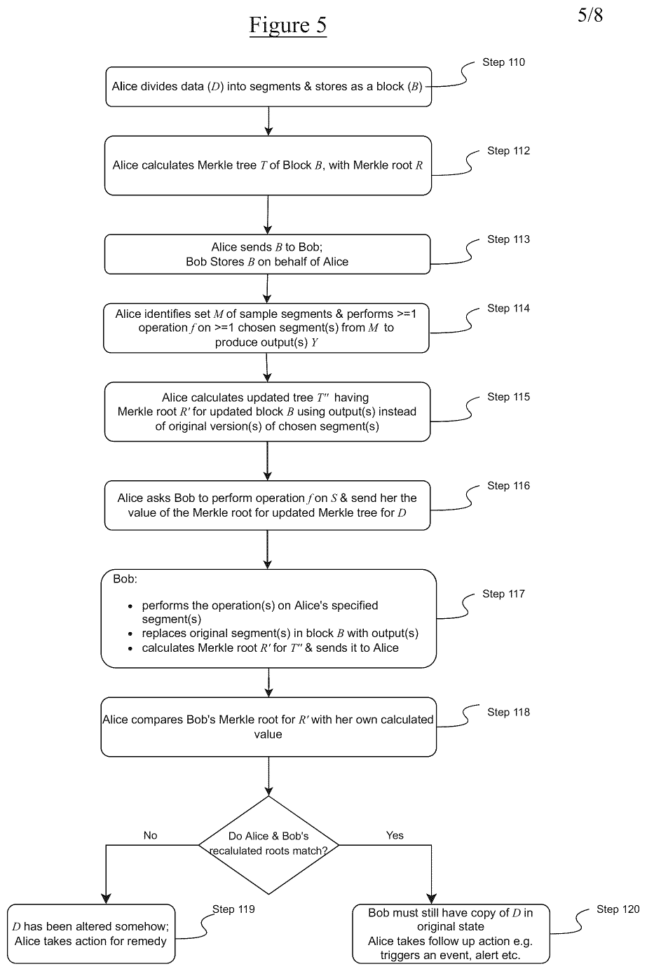

We now provide an example embodiment(s) of the disclosure for the purposes of illustration only, with particular reference to FIGS. 5 to 8.

Consider a scenario in which a first party (Alice, 1) who is a data controller needs to store a data item (D). We use the term “data controller” to include any party that has data which needs to be stored, and includes, but is not limited to meaning, an owner, creator, controller, handler, processor and/or authorised administrator of the data. The term “data item” is used to mean a portion of data, regardless of how it is structured, generated, formed, used or organised. For example, it may be one or more discrete data files, a collection of related data items such as database records, company accounts, associated media content, legal documents, contents of physical storage media such as disks etc.

Suppose that Alice 1 is either unable to store the entire data item herself or does not wish to do so. For example, her device may not comprise sufficient memory, or perhaps the data is sensitive, and she does not wish to store the data locally for security or liability reasons. Therefore, she needs to outsource the storage to another entity that will function as a storage provider (Bob, 2). Bob has, or at least has access to, a storage resource 3.

However, Alice 1 needs assurance that Bob 2:
does not lose the data item D; and/or
does not alter the data D, either deliberately or inadvertently e.g. if his device has been compromised by an exploit that corrupts the data, or his storage device fails without the ability to recover Alice's data.

Alice 1, therefore, needs verifiable proof that the data Bob2 is storing on her behalf is still in existence and in its original, unaltered state. She may need to obtain such proof at regular intervals—for example, she may want Bob 2 to prove safe storage every month—or at random/unscheduled times. A subsequent action may be contingent on Bob's successful or unsuccessful provision of proof. For example, if existence and state of the data is successfully verified, a signal or confirmatory electronic communication may be sent to a recipient, a file or record may be updated, an event may be triggered, a resource may be unlocked, a transfer may be made between transacting parties e.g. Alice sends a payment to Bob and so on. Similarly, if verification is unsuccessful then an event may be triggered, a communication may be sent to a recipient, a record/file may be updated. For example, an alert signal may be generated and transmitted, or some resource may be locked to prevent access etc.

In some embodiments, Bob may be an entirely separate entity from Alice, in that there may be no commercial or organization-based association between them, and/or no trust-based relationship. For example, Bob may be a third-party provider that offers data storage as a service to paying customers. In other embodiments, however, Bob may be known to, associated with and/or trusted by Alice. For example, Bob may comprise a data storage function or facility that forms part of an organization to which Alice belongs. Even if Bob is trusted by Alice, she may need verification from him that the data he is storing remains intact and unaltered. This may be, for example, because Alice needs to comply with regulatory, commercial or legal requirements relating to storage of (sensitive) data.

An example embodiment is now discussed with reference to FIGS. 5 to 8. It should be noted that steps as shown in FIG. 5 and set out in the description may, in practice, be performed in varying order. For example, the step of sending block B to Bob may be performed after or before Alice calculates the output Y. As long as Alice has identified and recorded her set of segments M before she deletes her whole copy of D. Other steps can also be performed in different orders and the disclosure is not limited in this regard.

In Step 110 of FIG. 5, Alice provides her data (D) in a block (B). It should be noted that the term “block” here is used to refer to a data block in the traditional computing sense (see en.wikipedia.org/wiki/Block_(data_storage), rather than in a “blockchain block” which is a structured set of blockchain transactions. As known in the general art of computing, data can be stored in blocks that comprise a body (or “payload”) and a header. The header comprises information relating to the data that is stored in the body of the block.

To do this, the data is organized in segments. These segments of the data item can also be referred to as “sub-portions”. In combination, the sub-portions/segments form an entire copy of the data item D (FIG. 5, step 110), and thus also combine to provide block B. The segments in the block are hashed in pairs, starting from the leaf nodes upwards, to calculate a Merkle tree T that represents all of the segments in block B. T and has a Merkle root (R) (FIG. 5, Step 112). As Merkle root R is derived from the hashes of all segments in the block, it can be used to verify D as explained below. The skilled person will readily understand the concepts and techniques involved in the generation and use of a Merkle tree—see en.wikipedia.org/wiki/Merkle_tree.

In FIG. 5 Step 114, Alice identifies a set (M) of one or more sample segments. Suppose, for our simple example, she selects three segments m₀, m₁, m₃ and stores them for future reference. In other possible embodiments, Alice may not store the segments in their original form. Instead, she might save them in some processed form e.g. in an encoded, hashed or compressed form. In such embodiments, Alice would then ask Bob to perform the verification operation by referring to the chosen segment(s) by some form of segment identifier and with the first step of the verification operation being the processing step. For example, if Alice stores her segments in hashed form she might ask Bob to perform the verification by concatenating ‘G’ to the hash of segment number 11001110. Advantages of storing the segments in a processed form rather than in their original form can include increased security and fewer storage resources required by Alice.

Whether stored in unprocessed or processed form, Alice's segments can be small e.g. 1 k bytes each, so storing them requires few resources on Alice's device. Alice may select her segment samples according to any criteria, such as every 10^{th} segment, or chosen at random from the set of M segments. Choosing at random may enhance security as it is then harder for a third party to predict which segment(s) she will store. Although embodiments of the disclosure can be implemented using only one chosen segment, the use of multiple segments provides an enhanced level of security as it further decreases Bob's ability to predict the proof that he will need to generate.

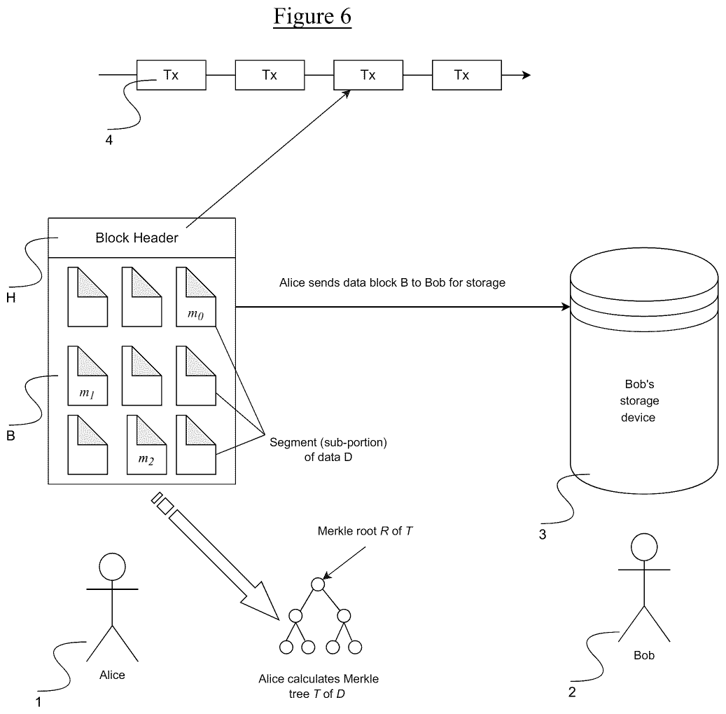

In FIG. 5 Step 113, and as also shown in FIG. 6, Alice sends the block B containing the whole of segmented data D to Bob with a request for him to store it on her behalf, which he does. (As shown in FIG. 6, the whole block that she sends includes the set of sample segments m₀, m₁, m₃). He stores Block B containing the data in a storage device(s) 3 that he controls or at least has the ability to send data to for storage. Storage device(s) 3 may comprise one or more databases, disks, servers or combinations of data storage mediums. However, Bob does not know which or how many segments Alice has chosen to retain.

The storage phase of this embodiment of the disclosure, shown in FIG. 6, is now complete. However, at some point in the future, Alice needs to check that Bob still has D and that it has not been altered in any way. Perhaps she wishes to do this at regular intervals, or at random times, or when a triggering event occurs e.g. at the start of each month, or if she notices that a new malware exploit has recently been active, or when a third party asks her to provide evidence of the existence of D in its original form etc. Alice needs proof of the existence and unaltered state of D in Bob's possession, so the verification phase begins.

In FIG. 5, at step 115, she calculates a (potentially small) change to one or more of her sample segments m₀, m₁, m₃ by performing some operation f on it or using it as an input/parameter to operation f She may choose the segments(s) from her preserved set M at random or according to a pre-determined criterium, such as taking the next unused segment in the set. The change that she makes to the chosen segment can produce any type of mutation. For example, it could involve a bitwise operation, or a Boolean operation, or a mathematical function etc. In our example, let us suppose that she appends the character ‘A’ to sample m₂. She now knows the result of this operation.

So if m₂ is:

0111001001001110

and ‘A’ (in ASCII) is 01000001, then she can calculate that

m2∥‘A’=011100100100111001000001

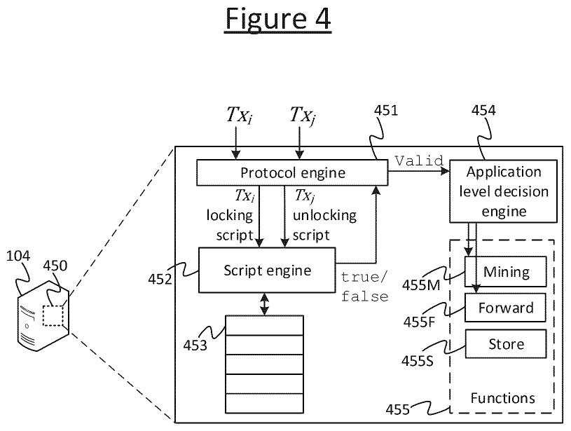

In step 115 of FIG. 4, Alice recalculates the Merkle tree, this time including the altered version of m₂ instead of its original version. As a result, Alice knows the value of the new Merkle root (R′) for the recalculated tree (T′).

In step 116 of FIG. 5 she requests that Bob makes the same alteration i.e. operation f on to segment m₂ in his version of D, and send her the result (i.e. his value for the Merkle root of the new tree containing the altered version of segment m₂). Therefore, in step 117, Bob has to make his calculation based upon the whole of D plus the operation specified by Alice. Alice may also have provided or specified certain parameters for use in the modification of the segment. If Bob no longer has an entire copy of D as provided by Alice, he will be unable to calculate the required Merkle root that Alice needs in order to verify his copy.

As Bob has an entire copy of D, Alice may discard her own complete copy once she has stored her samples m₀, m₁, m₃ and/or their hashes. Alice does not need to store the entire Merkle tree for block B either, but needs to retain the Merkle root value for it so that she can compare it against Bob's calculated in the verification stage described below.

### Communicating the Requested Modification to Bob

Alice may specify the relevant block and/or segments(s) by way of an identifier. The identifier for the block B may be provided in the header of the block B that Alice sends to Bob. The header may comprise the Merkle root R for the block, and this may be or form part of the identifier that is used in the verification request that is sent to Bob. The at least one segment that Alice requests he performs the operation on may be identifiable by an identifier that is unique within the block.

In another embodiment, Alice may use an encrypted or authenticated message technique, such as authentication code (MAC), to communicate the requested modification to Bob. This provides enhanced security as it provides Bob with the assurance that the message has genuinely come from Alice and not an unauthorised party. For example, Alice could send the information top Bob using HMAC, in which she provides the segment or its identifier and any relevant information such as the operation and/or operands in the message. HMAC techniques are known in the art, and Wikipedia (en.wikipedia.org/wiki/HMAC) provides a definition taken from RFC 2104:

$$HMAC ( K , m ) - H ( ( {K}^{′} ⊕ opad ) \vert H ( ( {K}^{′} ⊕ ipad ) \vert m ) ) \\ {K}^{′} - \{ \begin{matrix}H ( K ) & K is larger than block size \\ K & otherwise\end{matrix}$$

where
H is a cryptographic hash function
m is the message to be authenticated
K is the secret key K′ is a block-sized key derived from the secret key, K; either by padding to the right with 0s up to the block size, or by hashing down to less than or equal to the block size first and then padding to the right with zeros
∥ denotes concatenation
⊕ denotes bitwise exclusive OR (XOR)
opad is the block-sized outer padding, consisting of repeated bytes valued 0x5c
ipad is the block-sized inner padding, consisting of repeated bytes valued 0x36

In such an embodiment, the secret key can be generated using any known technique such as, but not limited to, those disclosed in WO/2017/145016, or the shared secret concepts and techniques mentioned at en.wikipedia.org/wiki/Secret_sharing and en.wikipedia.org/wiki/Shared_secret. Using such techniques, the process may be automated as described in more detail below.

### Success or Failure of the Verification

Upon receipt of Bob's calculated Merkle root, in FIG. 5 Step 118 Alice checks whether the value he has provided matches her expectation of what R′ should be. Recall that if a portion of data is changed in any way, the resulting hash of that data will not be the same as a hash of the original. Therefore, if one portion of data in block B has changed, the entire path and tree that it is in is altered, including the value of its Merkle root.

In FIG. 5 Step 120, if the value of Bob's recalculated Merkle root matches Alice's recalculated value, verification is deemed successful and she can be assured that Bob a) still has a complete copy of D, and b) has not altered any portion of D, because he needs a complete and unaltered copy of D in order to provide the correct recalculation. In FIG. 5 Step 119, if they do not match, then Alice and/or Bob can take remedial or alerting action of some form.

Although the operation that Alice chooses to perform can be more complex than the simple concatenation example used above, it does not need to be. As Bob does not know in advance which segment(s) will be chosen for verification purposes, and which operation(s), there is no feasible way for Bob to predict what Alice will ask him to do in order to provide the required proof.

### Various Options for Storage of the Data D

In an alternative embodiment, the data may not be stored in a data block but may be stored in any suitable, alternative form and on any suitable medium, in any suitable structure. Importantly, there needs to be a way in which Alice can identify and uniquely refer to particular segment(s) of the data so that she can communicate to Bob which segment(s) he is required to perform the verification operation(s) on. Similarly, Bob needs to be able interpret Alice's references and access the specified segment(s) from his storage resource(s). For example, Bob may store the data on sequential storage such as tape, and Alice may refer to segments via their byte number starting from byte #zero being the first byte written to the tape. In another variation, the data could be stored in a linked list, a DHT, a distributed database. The storage of the data might be distributed over more than once physical and/or logical storage device. For convenience only, we refer herein to storage of the data in a block but this should be interpreted as meaning any suitable way of storing the data such that that portion)s) of it may be identified and/or specified. Preferably, the chosen storage method and structure is arranged such that a header segment or sub-portion can be included to facilitate embodiments disclosed herein which require comprise use of a header H.

In some embodiments, Bob stores Alice's original block B of segmented data item D off chain in storage device(s) 3 as shown in FIG. 6. Although data can be stored in a blockchain in various ways, such an approach may not always be the desired or most efficient solution depending on the requirements and constraints of a particular implementation. Therefore, for efficiencies in processing time, resource and fees, in some cases it may be preferred to store block B in an off-chain storage resource such as storage 3 in FIG. 6.

However, a scenario may arise in which the original state of block B needs to be verified. For example, there may be a discrepancy between Alice and Bob as to what she sent him, or a third party may wish to verify that the copy Bob has stored actually does match Alice's original data item. In other words, the authenticity of original data item D needs to be verified as well. In order to solve this challenge, a preferred embodiment comprises a step wherein the header H of block B is written into a transaction (Tx) that includes the Merkle root for tree T of original block B is written to the ledger of a blockchain 4—see FIG. 6

### Simplified Payment Verification (SPV)

Embodiments of the disclosure allow the header H of the block to serve as an SPV-style marker or reference for the block of data. As known in the art of blockchain transactions, SPV can use the Merkle-tree structures that are built into blockchain blocks to simplify the transaction verification process and reduce the amount of storage and processing resources required. Instead of having to store an entire copy of the blockchain, the verifier can prove that a target transaction (Tx) is in a given block as long as they know the Merkle root for the block and sufficient information to calculate the path to the target transaction. This is advantageous for devices that have limited resources, such as digital wallets running on smaller devices. Further background information can be found in the art, for example, at medium.com/coinmonks/spv-proofs-explained-f38f8bb8f580.

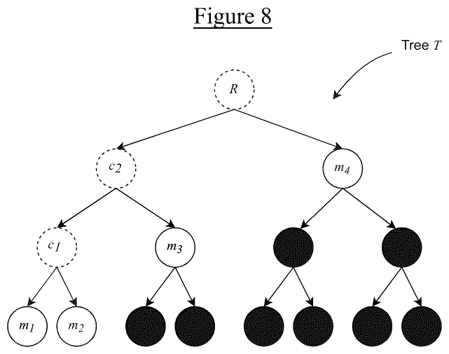

Similarly, FIG. 8 shows a Merkle tree that may be used in accordance with an embodiment of the disclosure, including sample segments {m₁, m₂, m₃, m₄}. In the same way that traditional SPV style verifications enable the verifier to minimise storage and processing, the disclosure enables Alice to calculate the Merkle root of a Merkle tree using only a minimal number of required data items, as long as Alice selects her sample segments appropriately.

By way of example, suppose that Alice's data is represented by the Merkle tree T shown in FIG. 8. She selects sample segments {m₁, m₂, m₃, m₄}. She does not need to store the segments shown in solid black or in dotted lines, she only needs her chosen samples because she can:
hash m₁ and m2 to calculate c₁
she can then hash c₁ and m3 to calculate c2
she can then hash c2 and m4 to calculate the Merkle root R of T.

It is clear, then, that this technique provides significant technical benefits including, but not limited to, enhanced speed and efficiency when performing verification and security processes. It should be noted, though, that while providing the same technical benefits as traditional-style SPV, the disclosed embodiments operate in an entirely different manner in order to achieve those results. In a traditional SPV approach, the Merkle root is known and the verifier constructs a downward path from the root to prove whether or not the target transaction is present in a lower level. By contrast, embodiments of the disclosure allow the verifier to start at the lower level and work upwards towards a calculated Merkle root which is then used to determine the success or failure of the verification.

As explained above, in use Alice and Bob can exchange messages via any suitable communication method to transmit the information required for a particular verification request. The verifier (Bob) can perform off-chain verification checks. The process can be partly or completely automated, and/or can be arranged to operate at least partially via a blockchain. Blockchain-implemented embodiments may be arranged to include locking mechanisms such as nLocktime-based conditions so that blockchain transactions can be exchanged between Alice and Bob and then settled later using SPV.

Enabling Data Verification Requests By Third Parties Advantageously, embodiments of the disclosure allow for the verification to be requested by Alice herself or some other entity. We call this third party Carole. For example, Alice can delegate or authorize verification to Carole, who may be e.g. a third party auditor or any entity (human, organisational or machine-based) that needs verification of existence and authenticity of Alice's stored data. Alice can use any suitable technique, such as those disclosed in WO/2017/145016, to send or share a secret with Carole. Carole can use the secret to request the verification proof from Bob by incorporating use of the shared secret into the operation used to modify the chosen segment(s) or replace them with different versions. Although the disclosure is not limited to their use for secret sharing, the techniques disclosed in WO/2017/145016 may be used to advantage because they allow for two parties to generate a shared secret independently of each other. Therefore, transmission of the secret and its potential interception in-transit can be avoided. This enhances security because if an unauthorised party were able to gain knowledge of the secret, they could potentially discern helpful information for predicting or discerning the calculation that Bob will be required to perform.

Advantageously, Alice does not need to give Carole access to her entire data storage e.g. her entire server or disk, if Carole only needs to verify certain item(s) within that storage space. Instead, she can send various data items to Bob (and potentially other service providers) in separate blocks, ask him to store each of the blocks in accordance with an embodiment described herein. When Carole requires verification, Bob can provide the required proof in respect of only the specific data item in the associated block. Therefore, embodiments allow delegation/authorization of third-party verification for specific data items, thus improving or at least preserving privacy of data and ringfencing storage of it so as to enhance security of other data items and/or storage resources.

Updating The Data Item D—Recording Incremental changes

It is possible that, over time, data item D changes, evolves or updates. For example, an initial document such as a “Last Will and Testament” may change as the testator ages; or a piece of musical arrangement may be adapted according to popular style; or a piece of software is amended to fix bugs. There is a plethora of reasons why data items may need to be changed or updated from their original form and thus there is a need for a technical solution as to how to capture and verifiably record such changes in data items. In such cases, there is a need to capture and verify:
The change relative to the original; and/or
The time when the adaptation occurred.

Consider a scenario in which Alice changes at least one segment of the data stored in block B. We will call the updated version B′. In accordance with one embodiment, the incremental changes or modifications may be recorded by Alice or a third party by specifying to Bob that one or more particular sub-portions must be changed. He may be required to record the details e.g. nature, time, form of the change, and the difference between the existing version and the new version. In one embodiment, this can be achieved by writing a transaction to the blockchain such that it records, on-chain, an “updating” link or reference from the first transaction (Tx₀) (that includes the header of block B) to a subsequent transaction (Tx₁). Tx₁ includes an altered version of at least one segment of block B, or a reference/pointer/link to where the updated altered segment(s) or an entire copy of B′ is located. Alice may communicate to Bob, via any suitable method, that the state of block B has been altered. Bob may access the altered segment(s) from a location specified by Alice, or Alice may communicate the relevant segment(s) to Bob via any chosen, suitable method. An advantage of using the blockchain is that it provides an immutable, auditable and time-stamped record of the modification.

Alternatively, or additionally, Bob may detect that block B has been modified. This could be achieved in a variety of ways. For example, an automated process may be used to monitor and detect the state of the data. One way of doing this could be to use an automated DFA such as, for example, a technique as disclosed in WO2018/078584. Bob may then access the altered (i.e. varied) segment(s) from a location specified by Alice, or Alice may communicate the relevant segment(s) to Bob via any chosen, suitable method.

Various permutations of such embodiments can be devised according to the needs to the particular scenario. For example, if only small changes are to be made to the data, Alice might include the modified segment(s) in a blockchain transaction, and Bob could access (for copying, downloading etc) from the transaction. She can embed the data in a transaction (Tx) in a variety of ways, such as including the modified data segment(s) as metadata in a script associated with an unspent output (UTXO). The new data may be included in a script at a location that is designated by the protocol associated with the blockchain as a location for a cryptographic key. This is the technique disclosed in WO2018/078584. Additionally, or alternatively, the data may be included in the script after an OP_RETURN statement, and/or using a tokenised digital asset, and/or including a hash of a reference to the data, or using a condensed, encoded, abbreviated, abridged and/or compressed version. For example, the modifications may be provided in a manner that Bob can extrapolate or calculate the modifications e.g. by unzipping a file, by performing a function or applying a process to the original data, or by any other known technique for deriving the desired output i.e. the modified data.

In accordance with another variation of the embodiment, when Alice updates data D she generates a blockchain transaction which spends the original transaction Tx₀ that includes the header (H). By “spends the transaction” we mean “spends at least one UTXO of the transaction” as would be readily understood by a person skilled in the art. The first transaction Tx₀ may be spent such that it transfers one or more digital assets to an input of second transaction Tx₁. In some embodiments, cryptographic keys controlled by Alice, Bob, and/or a third party, may be required to unlock the asset transferred to Tx₁.

Embodiments thus provide the ability to record changes to stored data and ensures that associated but different versions of the data are linked in a verifiable manner, potentially with a cryptographically enforced time stamp. This ensures the integrity of the data in its latest form such that the new version of the data can be relied upon, verified and evidenced. Thus, embodiments of the invention provide improved techniques for ensuring the integrity of data, which then enables the use of that data in other applications further “downstream” in technical processes that need to utilise that data in some way. For example, critical systems that involve safety and security may need to be able to reply on the integrity of the data that they use as input to their processes.

### Automated Embodiments

In certain situations, it may be advantageous to automate the processes described herein. This not only relieves Alice and/or Bob of the burden of performing parts of the process, but it also enables the process to be delegated to a third party resource, facilitating a different hardware/software architecture. It also enables separation and/or partition of technical processes, thus enhancing security.

For example, an automated resource (which may be referred to as an “oracle”, “bot” or “smart contract”) may be operative to perform the steps of the disclosed technique(s) without the need for manual, human intervention. Such automated resources, which we will refer to as “agents” for ease of reference, may be software-implemented entities that are executed upon one or more hardware devices, each comprising at least one processor.

Consider a scenario wherein Alice has a 12-month contract with Bob such that he will store her data on her behalf. Alice can automate the performance of the arrangement by determining a verification proof for each month. She can determine multiple Merkle roots in advance and use them in scheduled verification sessions, requiring Bob to provide the correct proof.

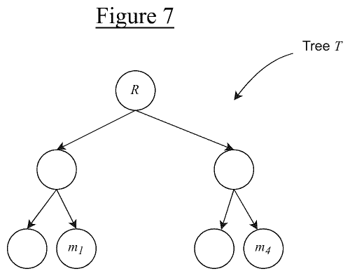

In such a scenario, Alice pre-calculates several different variations of R′. She selects or otherwise identifies different modifications to the data and calculates the respective Merkle paths and roots for each. For example, she selects or pre-determines at least one operation (f), at least one operand to the operation, and/or at least one segment that the operation will be performed on or use. She then calculates the Merkle root for each of the various modifications and records them. With reference to FIG. 5, this embodiment involves selecting more than one operation and/or segment in step 114, and then repeating the calculation of step 115 for each new Merkle tree T′ that comprises an output Y of the operation f Suppose that the tree shown in FIG. 7 is a Merkle tree T that represents Alice's data block B. Each node in the tree is a segment of the data D. Suppose that Alice selects segments m₁ and m₄ as sample segments.

She then performs an operation on each of the segments. Suppose that she alters m₁ by performing a bitwise XOR operation on it using a first mask, and then she does the same in respect of m₄ using a second mask. For example:
m1 ⊕01100011
m4 ⊕11001010

She can now calculate the Merkle root of the new tree resulting from the operation on m₁ and also the Merkle root of new tree resulting from the operation on m₄. She stores these two calculated Merkle roots.

She then sets up a blockchain transaction which specifies the various chosen segments and their respective masks so that Bob knows what he is being asked to calculate. The transaction can be arranged with a time lock mechanism which reveals the next required calculation at a desired time. For example, Alice can calculate 12 different Merkle roots using different sample segment(s) and/or masks, each of which will be spendable to Bob at the end of each month. Bob can respond to Alice each month by providing the verification in a HMAC:
HMAC₁(MerkleRoot₁, Secret₁)
HMAC₂(MerkleRoot₂, Secret₂)
etc

Therefore, Alice pre-determines a plurality of verification challenges which are then provided to Bob via the blockchain using an automated system. Bob is paid by Alice for his storage services upon successful verification at the end of each time period. A smart contract can be used to monitor or execute the performance of these steps.

The contents of international applications PCT/IB2017/050856, PCT/IB2017/056696 and PCT/IB2017/050819 are incorporated herein in their entirety.

### Example System Overview

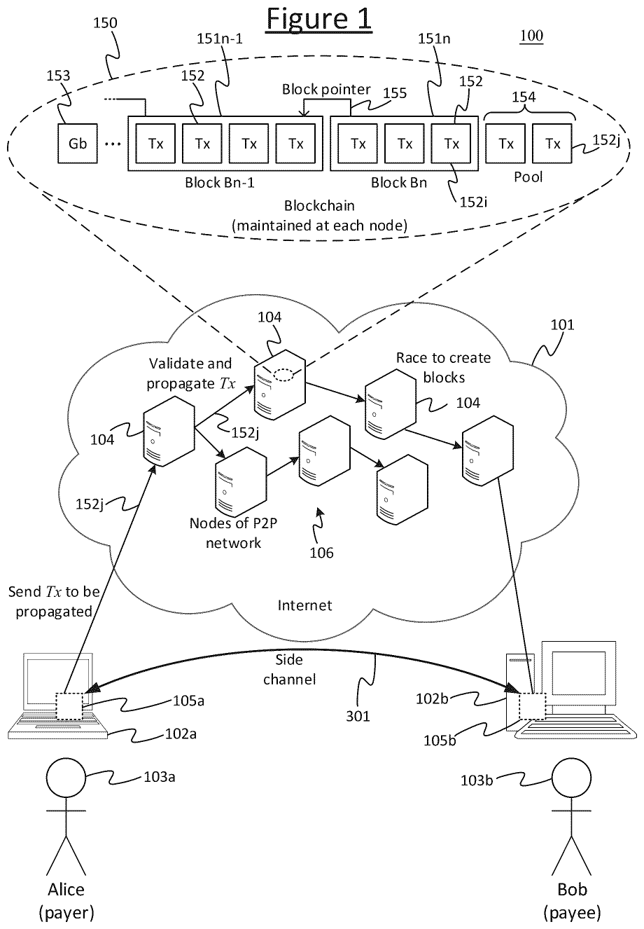

Certain embodiments (but not all) have been described above as being comprising the use of, or interacting with, a blockchain. We now provide an explanation of an example system which may be used for the implementation of such embodiment(s). It should be noted that, in accordance with standard terminology, the following refers to “Alice” and Bob” but that the use of these terms in the following overview are not coupled to the use of the same names in the preceding section. The following relates to FIGS. 1 to 4. It is also important to note that the following refers to the Bitcoin network, but a) the term “bitcoin” is intended herein to include all variations of, or deviations from, the original Bitcoin protocol; and b) reference to Bitcoin blockchain/protocol/network herein is used for the purpose of illustration only, and the disclosure is not intended to be limited in this regard, as non-Bitcoin blockchains/protocols/networks may be used for implementation of one or more embodiments of the disclosure, and fall within its scope.

The term “blockchain” refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below. Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example, blockchain protocols may allow for storage of additional user data or indexes to data in a transaction. There is no pre-specified limit to the maximum data capacity that can be stored within a single transaction, and therefore increasingly more complex data can be incorporated. For instance, this may be used to store an electronic document in the blockchain, or audio or video data.

Nodes of the blockchain network (which are often referred to as “miners”) perform a distributed transaction registration and verification process, which will be described in more detail later. In summary, during this process a node validates transactions and inserts them into a block template for which they attempt to identify a valid proof-of-work solution. Once a valid solution is found, a new block is propagated to other nodes of the network, thus enabling each node to record the new block on the blockchain. In order to have a transaction recorded in the blockchain, a user (e.g. a blockchain client application) sends the transaction to one of the nodes of the network to be propagated. Nodes which receive the transaction may race to find a proof-of-work solution incorporating the validated transaction into a new block. Each node is configured to enforce the same node protocol, which will include one or more conditions for a transaction to be valid. Invalid transactions will not be propagated nor incorporated into blocks. Assuming the transaction is validated and thereby accepted onto the blockchain, then the transaction (including any user data) will thus remain registered and indexed at each of the nodes in the blockchain network as an immutable public record.

The node who successfully solved the proof-of-work puzzle to create the latest block is typically rewarded with a new transaction called the “coinbase transaction” which distributes an amount of the digital asset, i.e. a number of tokens. The detection and rejection of invalid transactions is enforced by the actions of competing nodes who act as agents of the network and are incentivised to report and block malfeasance. The widespread publication of information allows users to continuously audit the performance of nodes. The publication of the mere block headers allows participants to ensure the ongoing integrity of the blockchain.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

Turning now to FIGS. 1 to 4, FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout. In one common type of transaction protocol, the data structure of each transaction 152 comprises at least one input and at least one output. Each output specifies an amount representing a quantity of a digital asset as property, an example of which is a user 103 to whom the output is cryptographically locked (requiring a signature or other solution of that user in order to be unlocked and thereby redeemed or spent). Each input points back to the output of a preceding transaction 152, thereby linking the transactions.

Each block 151 also comprises a block pointer 155 pointing back to the previously created block 151 in the chain so as to define a sequential order to the blocks 151. Each transaction 152 (other than a coinbase transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

Each of the blockchain nodes 104 is configured to forward transactions 152 to other blockchain nodes 104, and thereby cause transactions 152 to be propagated throughout the network 106. Each blockchain node 104 is configured to create blocks 151 and to store a respective copy of the same blockchain 150 in their respective memory. Each blockchain node 104 also maintains an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the input authorisation, for example the signature of the user 103a to whom the output of the preceding transaction 152i is locked. In turn, the output of the present transaction 152j can be cryptographically locked to a new user or entity 103b. The present transaction 152j can thus transfer the amount defined in the input of the preceding transaction 152i to the new user or entity 103b as defined in the output of the present transaction 152j. In some cases a transaction 152 may have multiple outputs to split the input amount between multiple users or entities (one of whom could be the original user or entity 103a in order to give change). In some cases a transaction can also have multiple inputs to gather together the amounts from multiple outputs of one or more preceding transactions, and redistribute to one or more outputs of the current transaction.

According to an output-based transaction protocol such as bitcoin, when a party 103, such as an individual user or an organization, wishes to enact a new transaction 152j (either manually or by an automated process employed by the party), then the enacting party sends the new transaction from its computer terminal 102 to a recipient. The enacting party or the recipient will eventually send this transaction to one or more of the blockchain nodes 104 of the network 106 (which nowadays are typically servers or data centres, but could in principle be other user terminals). It is also not excluded that the party 103 enacting the new transaction 152j could send the transaction directly to one or more of the blockchain nodes 104 and, in some examples, not to the recipient. A blockchain node 104 that receives a transaction checks whether the transaction is valid according to a blockchain node protocol which is applied at each of the blockchain nodes 104. The blockchain node protocol typically requires the blockchain node 104 to check that a cryptographic signature in the new transaction 152j matches the expected signature, which depends on the previous transaction 152i in an ordered sequence of transactions 152. In such an output-based transaction protocol, this may comprise checking that the cryptographic signature or other authorisation of the party 103 included in the input of the new transaction 152j matches a condition defined in the output of the preceding transaction 152i which the new transaction assigns, wherein this condition typically comprises at least checking that the cryptographic signature or other authorisation in the input of the new transaction 152j unlocks the output of the previous transaction 152i to which the input of the new transaction is linked to. The condition may be at least partially defined by a script included in the output of the preceding transaction 152i. Alternatively it could simply be fixed by the blockchain node protocol alone, or it could be due to a combination of these. Either way, if the new transaction 152j is valid, the blockchain node 104 forwards it to one or more other blockchain nodes 104 in the blockchain network 106. These other blockchain nodes 104 apply the same test according to the same blockchain node protocol, and so forward the new transaction 152j on to one or more further nodes 104, and so forth. In this way the new transaction is propagated throughout the network of blockchain nodes 104.

In an output-based model, the definition of whether a given output (e.g. UTXO) is assigned (e.g. spent) is whether it has yet been validly redeemed by the input of another, onward transaction 152j according to the blockchain node protocol. Another condition for a transaction to be valid is that the output of the preceding transaction 152i which it attempts to redeem has not already been redeemed by another transaction. Again if not valid, the transaction 152j will not be propagated (unless flagged as invalid and propagated for alerting) or recorded in the blockchain 150. This guards against double-spending whereby the transactor tries to assign the output of the same transaction more than once. An account-based model on the other hand guards against double-spending by maintaining an account balance. Because again there is a defined order of transactions, the account balance has a single defined state at any one time.

In addition to validating transactions, blockchain nodes 104 also race to be the first to create blocks of transactions in a process commonly referred to as mining, which is supported by “proof-of-work”. At a blockchain node 104, new transactions are added to an ordered pool 154 of valid transactions that have not yet appeared in a block 151 recorded on the blockchain 150. The blockchain nodes then race to assemble a new valid block 151 of transactions 152 from the ordered set of transactions 154 by attempting to solve a cryptographic puzzle. Typically, this comprises searching for a “nonce” value such that when the nonce is concatenated with a representation of the ordered pool of pending transactions 154 and hashed, then the output of the hash meets a predetermined condition. E.g. the predetermined condition may be that the output of the hash has a certain predefined number of leading zeros. Note that this is just one particular type of proof-of-work puzzle, and other types are not excluded. A property of a hash function is that it has an unpredictable output with respect to its input. Therefore this search can only be performed by brute force, thus consuming a substantive amount of processing resource at each blockchain node 104 that is trying to solve the puzzle.

The first blockchain node 104 to solve the puzzle announces this to the network 106, providing the solution as proof which can then be easily checked by the other blockchain nodes 104 in the network (once given the solution to a hash it is straightforward to check that it causes the output of the hash to meet the condition). The first blockchain node 104 propagates a block to a threshold consensus of other nodes that accept the block and thus enforce the protocol rules. The ordered set of transactions 154 then becomes recorded as a new block 151 in the blockchain 150 by each of the blockchain nodes 104. A block pointer 155 is also assigned to the new block 151n pointing back to the previously created block 151n-1 in the chain. The significant amount of effort, for example in the form of hash, required to create a proof-of-work solution signals the intent of the first node 104 to follow the rules of the blockchain protocol. Such rules include not accepting a transaction as valid if it assigns the same output as a previously validated transaction, otherwise known as double-spending. Once created, the block 151 cannot be modified since it is recognized and maintained at each of the blockchain nodes 104 in the blockchain network 106. The block pointer 155 also imposes a sequential order to the blocks 151. Since the transactions 152 are recorded in the ordered blocks at each blockchain node 104 in a network 106, this therefore provides an immutable public ledger of the transactions.

Note that different blockchain nodes 104 racing to solve the puzzle at any given time may be doing so based on different snapshots of the pool of yet-to-be published transactions 154 at any given time, depending on when they started searching for a solution or the order in which the transactions were received. Whoever solves their respective puzzle first defines which transactions 152 are included in the next new block 151n and in which order, and the current pool 154 of unpublished transactions is updated. The blockchain nodes 104 then continue to race to create a block from the newly-defined ordered pool of unpublished transactions 154, and so forth. A protocol also exists for resolving any “fork” that may arise, which is where two blockchain nodes104 solve their puzzle within a very short time of one another such that a conflicting view of the blockchain gets propagated between nodes 104.

In short, whichever prong of the fork grows the longest becomes the definitive blockchain 150. Note this should not affect the users or agents of the network as the same transactions will appear in both forks.

According to the bitcoin blockchain (and most other blockchains) a node that successfully constructs a new block 104 is granted the ability to newly assign an additional, accepted amount of the digital asset in a new special kind of transaction which distributes an additional defined quantity of the digital asset (as opposed to an inter-agent, or inter-user transaction which transfers an amount of the digital asset from one agent or user to another). This special type of transaction is usually referred to as a “coinbase transaction”, but may also be termed an “initiation transaction” or “generation transaction”. It typically forms the first transaction of the new block 151n. The proof-of-work signals the intent of the node that constructs the new block to follow the protocol rules allowing this special transaction to be redeemed later. The blockchain protocol rules may require a maturity period, for example 100 blocks, before this special transaction may be redeemed. Often a regular (non-generation) transaction 152 will also specify an additional transaction fee in one of its outputs, to further reward the blockchain node 104 that created the block 151n in which that transaction was published. This fee is normally referred to as the “transaction fee”, and is discussed blow.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one or more blockchain nodes 104 to which she is connected. E.g. this could be the blockchain node 104 that is best connected to Alice's computer 102. When any given blockchain node 104 receives a new transaction 152j, it handles it in accordance with the blockchain node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any blockchain node 104 that receives the transaction 152j will add the new validated transaction 152 to the ordered set of transactions 154 maintained at that blockchain node 104. Further, any blockchain node 104 that receives the transaction 152j will propagate the validated transaction 152 onward to one or more other blockchain nodes 104 in the network 106. Since each blockchain node 104 applies the same protocol, then assuming the transaction 152j is valid, this means it will soon be propagated throughout the whole network 106.

Once admitted to the ordered pool of pending transactions 154 maintained at a given blockchain node 104, that blockchain node 104 will start competing to solve the proof-of-work puzzle on the latest version of their respective pool of 154 including the new transaction 152 (recall that other blockchain nodes 104 may be trying to solve the puzzle based on a different pool of transactions154, but whoever gets there first will define the set of transactions that are included in the latest block 151. Eventually a blockchain node 104 will solve the puzzle for a part of the ordered pool 154 which includes Alice's transaction 152j). Once the proof-of-work has been done for the pool 154 including the new transaction 152j, it immutably becomes part of one of the blocks 151 in the blockchain 150. Each transaction 152 comprises a pointer back to an earlier transaction, so the order of the transactions is also immutably recorded.

Different blockchain nodes 104 may receive different instances of a given transaction first and therefore have conflicting views of which instance is ‘valid’ before one instance is published in a new block 151, at which point all blockchain nodes 104 agree that the published instance is the only valid instance. If a blockchain node 104 accepts one instance as valid, and then discovers that a second instance has been recorded in the blockchain 150 then that blockchain node 104 must accept this and will discard (i.e. treat as invalid) the instance which it had initially accepted (i.e. the one that has not been published in a block 151).

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

### Utxo-Based Model

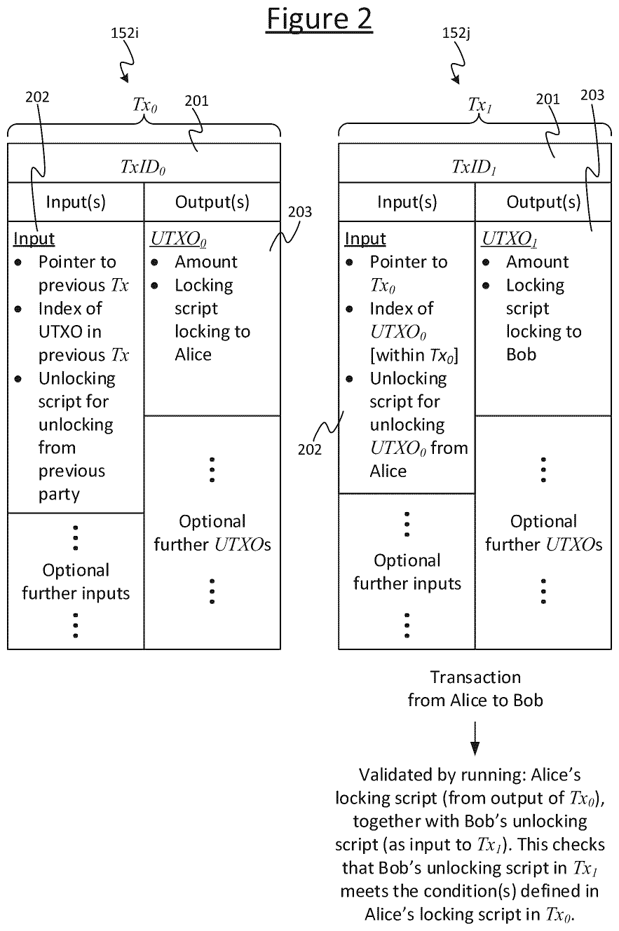

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in a block 151 of the blockchain 150 at the time when Alice creates her new transaction Tx₁, or at least by the time she sends it to the network 106. It may already have been included in one of the blocks 151 at that time, or it may be still waiting in the ordered set 154 in which case it will soon be included in a new block 151. Alternatively Tx₀ and Tx₁ could be created and sent to the network 106 together, or Tx₀ could even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria). In embodiments this involves concatenating the two scripts:
<Sig P_{A}><P_{A}>∥[Checksig P_{A}]
where “∥” represents a concatenation and “< . . . >” means place the data on the stack, and “[ . . . ]” is a function comprised by the locking script (in this example a stack-based language). Equivalently the scripts may be run one after the other, with a common stack, rather than concatenating the scripts. Either way, when run together, the scripts use the public key P_{A} of Alice, as included in the locking script in the output of Tx₀, to authenticate that the unlocking script in the input of Tx₁ contains the signature of Alice signing the expected portion of data. The expected portion of data itself (the “message”) also needs to be included in order to perform this authentication. In embodiments the signed data comprises the whole of Tx₁ (so a separate element does not need to be included specifying the signed portion of data in the clear, as it is already inherently present).

The details of authentication by public-private cryptography will be familiar to a person skilled in the art. Basically, if Alice has signed a message using her private key, then given Alice's public key and the message in the clear, another entity such as a node 104 is able to authenticate that the message must have been signed by Alice. Signing typically comprises hashing the message, signing the hash, and tagging this onto the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx₁ and authenticated), then the blockchain node 104 deems Tx₁ valid. This means that the blockchain node 104 will add Tx₁ to the ordered pool of pending transactions 154. The blockchain node 104 will also forward the transaction Tx₁ to one or more other blockchain nodes 104 in the network 106, so that it will be propagated throughout the network 106. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the blockchain node 104 also needs to check whether the referenced UTXO in the preceding transaction Tx₀ is already spent (i.e. whether it has already formed a valid input to another valid transaction). This is one reason why it is important for the blockchain 150 to impose a defined order on the transactions 152. In practice a given blockchain node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor included in a block 151.

Note that in UTXO-based transaction models, a given UTXO needs to be spent as a whole. It cannot “leave behind” a fraction of the amount defined in the UTXO as spent while another fraction is spent. However the amount from the UTXO can be split between multiple outputs of the next transaction. E.g. the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the bitcoin node 104 that successfully includes her transaction 104 in a block 151. If Alice does not include such a fee, Tx₀ may be rejected by the blockchain nodes 104, and hence although technically valid, may not be propagated and included in the blockchain 150 (the node protocol does not force blockchain nodes 104 to accept transactions 152 if they don't want). In some protocols, the transaction fee does not require its own separate output 203 (i.e. does not need a separate UTXO). Instead any difference between the total amount pointed to by the input(s) 202 and the total amount of specified in the output(s) 203 of a given transaction 152 is automatically given to the blockchain node 104 publishing the transaction. E.g. say a pointer to UTXO₀ is the only input to Tx₁, and Tx₁ has only one output UTXO₁. If the amount of the digital asset specified in UTXO₀ is greater than the amount specified in UTXO₁, then the difference may be assigned by the node 104 that wins the proof-of-work race to create the block containing UTXO₁. Alternatively or additionally however, it is not necessarily excluded that a transaction fee could be specified explicitly in its own one of the UTXOs 203 of the transaction 152.

Alice and Bob's digital assets consist of the UTXOs locked to them in any transactions 152 anywhere in the blockchain 150. Hence typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the bitcoin nodes 104.

Note that the script code is often represented schematically (i.e. not using the exact language). For example, one may use operation codes (opcodes) to represent a particular function. “OP_. . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain. Typically an input of a transaction contains a digital signature corresponding to a public key P_{A}. In embodiments this is based on the ECDSA using the elliptic curve secp256 k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### Side Channel

As shown in FIG. 1, the client application on each of Alice and Bob's computer equipment 102a, 120b, respectively, may comprise additional communication functionality. This additional functionality enables Alice 103a to establish a separate side channel 107 with Bob 103b (at the instigation of either party or a third party). The side channel 107 enables exchange of data separately from the blockchain network. Such communication is sometimes referred to as “off-chain” communication. For instance this may be used to exchange a transaction 152 between Alice and Bob without the transaction (yet) being registered onto the blockchain network 106 or making its way onto the chain 150, until one of the parties chooses to broadcast it to the network 106. Sharing a transaction in this way is sometimes referred to as sharing a “transaction template”. A transaction template may lack one or more inputs and/or outputs that are required in order to form a complete transaction. Alternatively or additionally, the side channel 107 may be used to exchange any other transaction related data, such as keys, negotiated amounts or terms, data content, etc.

The side channel 107 may be established via the same packet-switched network 101 as the blockchain network 106. Alternatively or additionally, the side channel 301 may be established via a different network such as a mobile cellular network, or a local area network such as a local wireless network, or even a direct wired or wireless link between Alice and Bob's devices 102a, 102b. Generally, the side channel 107 as referred to anywhere herein may comprise any one or more links via one or more networking technologies or communication media for exchanging data “off-chain”, i.e. separately from the blockchain network 106. Where more than one link is used, then the bundle or collection of off-chain links as a whole may be referred to as the side channel 107. Note therefore that if it is said that Alice and Bob exchange certain pieces of information or data, or such like, over the side channel 107, then this does not necessarily imply all these pieces of data have to be send over exactly the same link or even the same type of network.

### Client Software

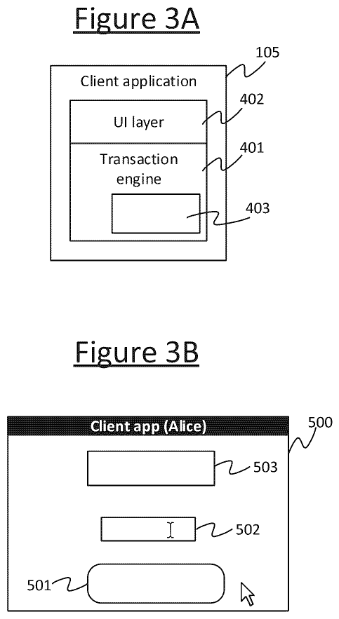

FIG. 3A illustrates an example implementation of the client application 105 for implementing embodiments of the presently disclosed scheme. The client application 105 comprises a transaction engine 401 and a user interface (UI) layer 402. The transaction engine 401 is configured to implement the underlying transaction-related functionality of the client 105, such as to formulate transactions 152, receive and/or send transactions and/or other data over the side channel 301, and/or send transactions to one or more nodes 104 to be propagated through the blockchain network 106, in accordance with the schemes discussed above and as discussed in further detail shortly.

The UI layer 402 is configured to render a user interface via a user input/output (I/O) means of the respective user's computer equipment 102, including outputting information to the respective user 103 via a user output means of the equipment 102, and receiving inputs back from the respective user 103 via a user input means of the equipment 102. For example the user output means could comprise one or more display screens (touch or non-touch screen) for providing a visual output, one or more speakers for providing an audio output, and/or one or more haptic output devices for providing a tactile output, etc. The user input means could comprise for example the input array of one or more touch screens (the same or different as that/those used for the output means); one or more cursor-based devices such as mouse, trackpad or trackball; one or more microphones and speech or voice recognition algorithms for receiving a speech or vocal input; one or more gesture-based input devices for receiving the input in the form of manual or bodily gestures; or one or more mechanical buttons, switches or joysticks, etc.

Note: whilst the various functionality herein may be described as being integrated into the same client application 105, this is not necessarily limiting and instead they could be implemented in a suite of two or more distinct applications, e.g. one being a plug-in to the other or interfacing via an API (application programming interface). For instance, the functionality of the transaction engine 401 may be implemented in a separate application than the UI layer 402, or the functionality of a given module such as the transaction engine 401 could be split between more than one application. Nor is it excluded that some or all of the described functionality could be implemented at, say, the operating system layer. Where reference is made anywhere herein to a single or given application 105, or such like, it will be appreciated that this is just by way of example, and more generally the described functionality could be implemented in any form of software.

FIG. 3B gives a mock-up of an example of the user interface (UI) 500 which may be rendered by the UI layer 402 of the client application 105a on Alice's equipment 102a. It will be appreciated that a similar UI may be rendered by the client 105b on Bob's equipment 102b, or that of any other party.

By way of illustration FIG. 3B shows the UI 500 from Alice's perspective. The UI 500 may comprise one or more UI elements 501, 502, 502 rendered as distinct UI elements via the user output means.

For example, the UI elements may comprise one or more user-selectable elements 501 which may be, such as different on-screen buttons, or different options in a menu, or such like. The user input means is arranged to enable the user 103 (in this case Alice 103a) to select or otherwise operate one of the options, such as by clicking or touching the UI element on-screen, or speaking a name of the desired option (N.B. the term “manual” as used herein is meant only to contrast against automatic, and does not necessarily limit to the use of the hand or hands).

Alternatively or additionally, the UI elements may comprise one or more data entry fields 502, through which the user can . . . . These data entry fields are rendered via the user output means, e.g. on-screen, and the data can be entered into the fields through the user input means, e.g. a keyboard or touchscreen. Alternatively the data could be received orally for example based on speech recognition.

Alternatively or additionally, the UI elements may comprise one or more information elements 503 output to output information to the user. E.g. this/these could be rendered on screen or audibly.

It will be appreciated that the particular means of rendering the various UI elements, selecting the options and entering data is not material. The functionality of these UI elements will be discussed in more detail shortly. It will also be appreciated that the UI 500 shown in FIG. 3 is only a schematized mock-up and in practice it may comprise one or more further UI elements, which for conciseness are not illustrated.

### Node Software

FIG. 4 illustrates an example of the node software 450 that is run on each blockchain node 104 of the network 106, in the example of a UTXO- or output-based model. Note that another entity may run node software 450 without being classed as a node 104 on the network 106, i.e. without performing the actions required of a node 104. The node software 450 may contain, but is not limited to, a protocol engine 451, a script engine 452, a stack 453, an application-level decision engine 454, and a set of one or more blockchain-related functional modules 455. Each node 104 may run node software that contains, but is not limited to, all three of: a consensus module 455C (for example, proof-of-work), a propagation module 455P and a storage module 455S (for example, a database). The protocol engine 401 is typically configured to recognize the different fields of a transaction 152 and process them in accordance with the node protocol. When a transaction 152j (Txⱼ) is received having an input pointing to an output (e.g. UTXO) of another, preceding transaction 152i (Txₘ₋₁), then the protocol engine 451 identifies the unlocking script in Txⱼ and passes it to the script engine 452. The protocol engine 451 also identifies and retrieves Txᵢ based on the pointer in the input of Txⱼ. Txᵢ may be published on the blockchain 150, in which case the protocol engine may retrieve Txᵢ from a copy of a block 151 of the blockchain 150 stored at the node 104. Alternatively, Txᵢ may yet to have been published on the blockchain 150. In that case, the protocol engine 451 may retrieve Txᵢ from the ordered set 154 of unpublished transactions maintained by the node104. Either way, the script engine 451 identifies the locking script in the referenced output of Txᵢ and passes this to the script engine 452.

The script engine 452 thus has the locking script of Txᵢ and the unlocking script from the corresponding input of Txⱼ. For example, transactions labelled Tx₀ and Tx₁ are illustrated in FIG. 2, but the same could apply for any pair of transactions. The script engine 452 runs the two scripts together as discussed previously, which will include placing data onto and retrieving data from the stack 453 in accordance with the stack-based scripting language being used (e.g. Script).

By running the scripts together, the script engine 452 determines whether or not the unlocking script meets the one or more criteria defined in the locking script—i.e. does it “unlock” the output in which the locking script is included? The script engine 452 returns a result of this determination to the protocol engine 451. If the script engine 452 determines that the unlocking script does meet the one or more criteria specified in the corresponding locking script, then it returns the result “true”. Otherwise it returns the result “false”.

In an output-based model, the result “true” from the script engine 452 is one of the conditions for validity of the transaction. Typically there are also one or more further, protocol-level conditions evaluated by the protocol engine 451 that must be met as well; such as that the total amount of digital asset specified in the output(s) of Txⱼ does not exceed the total amount pointed to by its inputs, and that the pointed-to output of Txᵢ has not already been spent by another valid transaction. The protocol engine 451 evaluates the result from the script engine 452 together with the one or more protocol-level conditions, and only if they are all true does it validate the transaction Txⱼ. The protocol engine 451 outputs an indication of whether the transaction is valid to the application-level decision engine 454. Only on condition that Txⱼ is indeed validated, the decision engine 454 may select to control both of the consensus module 455C and the propagation module 455P to perform their respective blockchain-related function in respect of Txⱼ. This comprises the consensus module 455C adding Txⱼ to the node's respective ordered set of transactions 154 for incorporating in a block 151, and the propagation module 455P forwarding Txⱼ to another blockchain node 104 in the network 106. Optionally, in embodiments the application-level decision engine 454 may apply one or more additional conditions before triggering either or both of these functions. E.g. the decision engine may only select to publish the transaction on condition that the transaction is both valid and leaves enough of a transaction fee.

Note also that the terms “true” and “false” herein do not necessarily limit to returning a result represented in the form of only a single binary digit (bit), though that is certainly one possible implementation. More generally, “true” can refer to any state indicative of a successful or affirmative outcome, and “false” can refer to any state indicative of an unsuccessful or non-affirmative outcome. For instance in an account-based model, a result of “true” could be indicated by a combination of an implicit, protocol-level validation of a signature and an additional affirmative output of a smart contract (the overall result being deemed to signal true if both individual outcomes are true).

### CONCLUSION

Other variants or use cases of the disclosed techniques may become apparent to the person skilled in the art once given the disclosure herein. The scope of the disclosure is not limited by the described embodiments but only by the accompanying claims. For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the disclosure, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the disclosure, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

### Enumerated Statements

It will be appreciated that the above embodiments have been described by way of example only. More generally there may be provided a method, apparatus or program in accordance with any one or more of the following Statements.

In statement 1 (alternative wordings 1a to 1h) the first entity may be Alice and/or the second entity may be Bob, or entities authorised or instructed by Alice/Bob to act on their behalf. The third entity may be Carol. Alice may keep the requested variation secret from Bob prior to sending the request to him. Any feature set out below in respect of one of the statements 2 onwards may be incorporated into any one or more of the other alternative wordings of statement 1a to 1h. In the following statements, the term “request/requesting” may be replaced with “instruct/instructing/instruction”.

Statement 1 (comprising alternative wordings statement 1a to statement 1.h):
1.a There may be provided a computer-implemented method comprising the steps:
   requesting, by a first entity from a second entity, the root value (R′) of a Merkle tree (T′) calculated based on a variation of at least one of a plurality of sub-portions of a portion of data (D);
   and/or
   providing, from a second entity to a first entity, the root value (R′) of a Merkle tree (T′) calculated based on a variation of at least one of a plurality of sub-portions of a portion of data (D).
1.b Additionally, or alternatively, there may be provided a (computer-implemented) method comprising the steps:
   requesting, by a first entity from a second entity, the root value (R′) of a Merkle tree (T′) calculated based on a variation of at least one of a plurality of sub-portions of a portion of data (D).
1.c Additionally, or alternatively, there may be provided a (computer-implemented) method comprising the steps:
   providing, from a second entity to a first entity, the root value (R′) of a Merkle tree (T′) calculated based on a variation of at least one of a plurality of sub-portions of a portion of data (D).
1.d Additionally, or alternatively, there may be provided a (computer-implemented) method comprising the steps:
   providing, from a second entity to a first entity, the root value (R′) of a Merkle tree (T′) calculated based on a variation of at least one of a plurality of sub-portions of a portion of data (D); and
   receiving, from the second entity and/or a party authorised on behalf of the second entity, the root value (R′) of a Merkle tree (T″) calculated based on variation of at least one of the sub-portions.
1.e Additionally, or alternatively, there may be provided a (computer-implemented) method comprising the steps:
   sending a portion of data D from a first entity to a second entity;
   sending a request, from the first entity or a third entity to the second entity, to calculate the output of a challenge based on a modified version of the portion of data:
   checking, by the first entity or a third entity, whether the output calculated by the second entity matches an output calculated by the first or third entity for the same challenge;
   and preferably wherein the method further comprises one or more of:
      i) storing, by the first or a third party, at least one, some or all of the one or more sub-portions;
      ii) selecting or otherwise identifying, by a first entity, at least one sub-portion of a portion of data (D);
      iii) keeping, by the first entity and/or third entity, the at least one sub-portion and/or at least one operation secret from the second entity;
      iv) calculating the output of the challenge comprises the steps of calculating:
         a modified version of the portion of data by performing at least one operation on at least one sub-portion of the portion of data, the at least one sub-portion being specified in the request; and
         the root value of the Merkle tree which represents the modified version of the portion of data;
      v) the step of checking comprises checking whether the root value calculated by the second entity matches a root value calculated by the first or third entity
1.f Additionally, or alternatively, there may be provided a (computer-implemented) method of verifying, backing-up, recovering and/or maintaining a portion of data D, the method comprising the steps:
   storing, by a second entity, the portion of data;
   performing a verification check, by a first or third entity, by comparing a challenge output calculated by the second entity with a challenge output calculated by the first and/or third entity;
   wherein calculation of the challenge output comprises calculation of:
      a modified version of the portion of data by performing at least one operation on at least one sub-portion of the portion of data, the at least one sub-portion being specified in the request; and
      the root value of the Merkle tree which represents the modified version of the portion of data;
   and preferably wherein the method comprises at least one of:
      sending the portion of data D from the first entity to the second entity;
      sending a request, from the first entity or the third entity to the second entity, to calculate the output of a challenge based on a modified version of the portion of data:
      checking, by the first entity or a third entity, whether the output calculated by the second entity matches an output calculated by the first or third entity for the same challenge;
      the at least one sub-portion is an element in a set of sub-portions (M) identified and/or selected from the plurality of sub-portions; and the set of sub-portions (M) is identified such that it allows calculation of a root value (R′) using the fewest number of calculations.
1.g Additionally, or alternatively, there may be provided a (computer-implemented) method comprising the step:
   receiving a request, by a data storer from or on behalf of a data provider, for the root value of a Merkle tree for a modified (i.e. varied) version of a portion of data that is/has been stored by, at or on behalf of a data storer.

Preferably, the modified version of the data is specified by or on behalf of the data provider and the data provider may specify one or more modifications to be made by the data storer to one or more segments (sub-portions) of the data prior to calculating the root value for the Merkle tree. The data storer may be called the second entity. The data provider may be called the first entity. The one or more modifications may be called one or more variations. The request may comprise a request or instruction to a) modify one or more sub-portions of the data and/or b) calculate the root value.
1.h Additionally, or alternatively, there may be provided a (computer-implemented) method comprising the step:
   requesting, by or on behalf of a data provider to/of a data storer, the root value of a Merkle tree for a modified (i.e. varied) version of a portion of data that is stored by, at or on behalf of the data storer.

Preferably, the modified version of the data is specified by or on behalf of the data provider and the data provider may specify one or more modifications to be made by the data storer to one or more segments (sub-portions) of the data prior to calculating the root value for the Merkle tree. The data storer may be called the second entity. The data provider may be called the first entity. The one or more modifications may be called one or more variations. The step of requesting the root value may comprise a request to a) modify one or more sub-portions of the data and/or b) calculate the root value.

One or more of the following statements can be applied to any of statements 1a to 1h. The phrase “statement 1” as used below means “any one or more of statements 1a to 1h.

### Statement 2:

A method according to statement 1, wherein the variation of the at least one the sub-portion is performed or provided:
i) by or on behalf of the second entity; and/or
ii) using at least one operation specified by the first entity; and/or
iii) by using at least one operation (f) on the at least one sub-portion to produce an output (Y);
iv) by using the at least one sub-portion as an operand or input to at least one operation (f)
v) by using a bitwise, logical, mathematical or cryptographic operation.

The term “operation” is intended to include any function, process, procedure, subroutine or method that produces a transformed, varied or processed version of a value. The sub-portions may be used by this operation as operand(s) or inputs of some kind.

Statement 3: A method according to Statement 1 or 2, wherein
i) the portion of data (D) is stored by and/or provided to the second entity as a data block (B), the data block comprising the at least one sub-portion; and/or
ii) the first entity is an owner, creator, controller, handler, processor and/or administrator of the portion of data; and/or
iii) the second entity is a storage provider.

Statement 4: A method according to any preceding Statement, wherein the at least one sub-portion is:
i) identified by the first entity; and/or
ii) an element in a set of one or more sub-portions (M) identified by the first entity from the plurality of sub-portions; and/or
iii) a sample of the portion of data (D); and/or
iv) identifiable by an identifier that is unique within the plurality of sub-portions and/or set of one or more sub-portions (M).

Statement 5: A method according to any preceding Statement, and comprising the step:
i) storing the portion of data (D) by the second entity in a storage resource;
ii) receiving, from the second entity by the first entity, the root value (R′); and/or
iii) comparing the root value (R′) received from the second entity with a pre-calculated root value calculated by the first entity.

Statement 6. A method according to any preceding Statement, wherein the method comprises:
i) storing, by or on behalf of the second entity, the portion of data (D), preferably where it is stored in an off-chain storage resource;
ii) storing a header (H) for a data block (B) comprising the portion of data (D) in a transaction (Tx) on a blockchain.

Statement 7: A method according to any preceding Statement, and comprising one or more of:
i) triggering an action in response to a comparison of the root value provided from the second entity to a first entity, preferably wherein the action is the transmission of a signal or electronic communication or the unlocking of a resource; and/or
ii) comparing the root value (R′) received from the second entity with a pre-calculated root value calculated by the first entity and deeming verification (of the portion of data (D)) to be successful if the received root value (R′) matches the pre-calculated root value, or unsuccessful if the received root value (R′) does not match the pre-calculated root value.

Statement 8: A method according to any preceding Statement, and further comprising:
requesting, by the first entity from the second entity, the root value of a further Merkle tree calculated based on a further variation of the at least one sub-portion; and/or providing, from the second entity to the first entity, the root value of a further Merkle tree calculated based on further variation of at the least one sub-portion.

Statement 9: A method according to any preceding Statement, wherein:
the at least one sub-portion is an element in a set of sub-portions (M) identified from the plurality of sub-portions; and
the set of sub-portions (M) is identified such that it allows calculation of the root value (R′) using the fewest number of calculations.

Statement 10: A method according to any preceding Statement, wherein:
the at least one sub-portion is an element in a set of sub-portions (M) identified from the plurality of sub-portions; and
and the method further comprises the step of:
   determining, by the first entity, a plurality of predetermined challenges based on a plurality of variations to the set of sub-portions (M).

The challenge may be or comprise the calculation of an output to a chosen/pre-determined operation, wherein the chosen operation may be arranged to operate on or otherwise use one or more sub-portions to produce a result that is based or dependent on the sub-portion(s).

Statement 11: A method according to any preceding Statement, wherein the method is a method of verifying the existence, state, integrity, consistency, persistence, storage and/or security of the portion of data (D);
additionally or alternatively, it may be a method for performing one or more of: a data back-up and/or recovery, data archiving, a file system dump and/or data versioning activity.

Statement 12. Computer equipment comprising:
memory comprising one or more memory units; and
processing apparatus comprising one or more processing units,
wherein the memory stores code arranged to run on the processing apparatus, the code being configured so as when on the processing apparatus to perform the method of any preceding Statement.

Statement 13. A computer program embodied on computer-readable storage and configured so as, when run on one or more processors, to perform the method of any of Statement 1 to 11.

1. A computer-implemented method comprising the steps:
i) requesting, by a first entity from a second entity, a root value (R′) of a Merkle tree (T′) calculated based on a variation of at least one of a plurality of sub-portions of a portion of data (D);
or
providing, from a second entity to a first entity, the root value (R′) of a Merkle tree (T′) calculated based on a variation of at least one of a plurality of sub-portions of a portion of data (D); and
ii) comparing, by the first entity, a root value (R′) received from the second entity with a pre-calculated root value calculated by the first entity and deeming verification of the portion of data (D) to be successful if the received root value (R′) matches the pre-calculated root value, or unsuccessful if the received root value (R′) does not match the pre-calculated root value.

2. The method of claim 1, wherein the variation of the at least one the sub-portion is performed or provided:
i) by or on behalf of the second entity; and/or
ii) using at least one operation specified by the first entity; and/or
iii) by using at least one operation (f) on the at least one sub-portion to produce an output (Y); and/or
iv) by using the at least one sub-portion as an operand or input to at least one operation (f);
and/or
v) by using a bitwise, logical, mathematical or cryptographic operation.

3. The method of claim 1, wherein
i) the portion of data (D) is stored by and/or provided to the second entity as a data block (B), the data block comprising the at least one sub-portion; and/or
ii) the first entity is an owner, creator, controller, handler, processor and/or administrator of the portion of data; and/or
iii) the second entity is a storage provider.

4. The method of claim 1, wherein
the at least one sub-portion is:
i) identified by the first entity; and/or
ii) an element in a set of one or more sub-portions (M) identified by the first entity from the plurality of sub-portions; and/or
iii) a sample of the portion of data (D); and/or
iv) identifiable by an identifier that is unique within the plurality of sub-portions and/or set of one or more sub-portions (M).

5. The method of claim 1, and
comprising one or more of the following steps:
i) storing the portion of data (D) by the second entity in a storage resource;
ii) receiving, from the second entity by the first entity, the root value (R′);
iii) comparing the root value (R′) received from the second entity with a pre-calculated root value calculated by the first entity.

6. The method of claim 1, wherein the method comprises one or both of:
i) storing, by or on behalf of the second entity, the portion of data (D), preferably where it is stored in an off-chain storage resource;
ii) storing a header (H) for a data block (B) comprising the portion of data (D) in a transaction (Tx) on a blockchain.

7. The method of claim 1, and comprising one or more of:
triggering an action in response to a comparison of the root value provided from the second entity to a first entity, preferably wherein the action is transmission of a signal or electronic communication or he-unlocking of a resource.

8. The method of claim 1, and further comprising:
requesting, by the first entity from the second entity, the root value of a further Merkle tree calculated based on a further variation of the at least one sub-portion; and/or
providing, from the second entity to the first entity, the root value of a further Merkle tree calculated based on further variation of at the least one sub-portion.

9. The method of claim 1, wherein:
the at least one sub-portion is an element in a set of sub-portions (M) identified from the plurality of sub-portions; and
the set of sub-portions (M) is identified such that it allows calculation of the root value (R) using the fewest number of calculations.

10. The method of claim 1, wherein:
i) the at least one sub-portion is an element in a set of sub-portions (M) identified from the plurality of sub-portions; and/or
ii) the method further comprises the step of:
determining, by the first entity, a plurality of predetermined challenges based on a plurality of variations to the set of sub-portions (M).

11. The method of claim 1, wherein the method is a method of:
i) verifying an existence, state, integrity, consistency, persistence, storage and/or security of the portion of data (D); and/or
ii) performing a data back-up and/or recovery, data archiving, a file system dump and/or data versioning activity.

12. Computer equipment comprising:
memory comprising one or more memory units; and
processing apparatus comprising one or more processing units,
wherein the memory stores code arranged to run on the processing apparatus, the code being configured so as when run on the processing apparatus, the processing apparatus performs a method of:
i) requesting, by a first entity from a second entity, a root value (R′) of a Merkle tree (T) calculated based on a variation of at least one of a plurality of sub-portions of a portion of data (D);
or
providing, from a second entity to a first entity, the root value (R′) of a Merkle tree (T) calculated based on a variation of at least one of a plurality of sub-portions of a portion of data (D); and
ii) comparing, by the first entity, a root value (R′) received from the second entity with a pre-calculated root value calculated by the first entity and deeming verification of the portion of data (D) to be successful if the received root value (R′) matches the pre-calculated root value, or unsuccessful if the received root value (R′) does not match the pre-calculated root value.

13. A computer program embodied on non-transitory computer-readable storage media and configured so as, when run on one or more processors, the one or more processors perform a method of
i) requesting, by a first entity from a second entity, a root value (R′) of a Merkle tree (T) calculated based on a variation of at least one of a plurality of sub-portions of a portion of data (D);
or
providing, from a second entity to a first entity, the root value (R′) of a Merkle tree (T) calculated based on a variation of at least one of a plurality of sub-portions of a portion of data (D); and
ii) comparing, by the first entity, a root value (R′) received from the second entity with a pre-calculated root value calculated by the first entity and deeming verification of the portion of data (D) to be successful if the received root value (R′) matches the pre-calculated root value, or unsuccessful if the received root value (R′) does not match the pre-calculated root value.
